(19) United States
(12) Patent Application Publication
(10) Pub. No.: US 2025/0371671 A1
(43) Pub. Date: Dec. 4, 2025

(54) METHOD AND APPARATUS FOR IMAGE PROCESSING, ELECTRONIC DEVICE AND STORAGE MEDIUM

(71) Applicant: Lemon Inc., Grand Cayman (KY)

(72) Inventors: Yangyue WAN, Los Angeles, CA (US); Xiaohui SHEN, Los Angeles, CA (US)

(21) Appl. No.: 18/873,688

(22) PCT Filed: Jun. 1, 2023
(86) PCT No.: PCT/SG2023/050392

§ 371 Date: Dec. 10, 2024

(30) Foreign Application Priority Data
Jun. 10, 2022 (CN) 202210657612.2

(51) Int. Cl. G06T 5/50; G06T 7/13

(52) U.S. Cl. CPC G06T 5/50; G06T 7/13

(57) ABSTRACT

A method and an apparatus for image processing, electronic device and a storage medium are configured for: obtaining an image to be processed that is an image with a preset object, respective portions of pixels of the preset object are respectively located in and outside a subject contour region in the image to be processed; obtaining a target image by inputting the image to be processed to a preset object removal processing model, the target image is an object removal image corresponding to the image with the preset object; the model trained on a pre-established set of image sample pairs without the preset object, wherein each image sample pair comprises an original image with a preset object, and a preset object removal image obtained by processing respective pixels of a preset object respectively located outside and in the subject contour region in the original image.

This application claims the benefit of Chinese Patent Application No. 202210657612.2, filed on Jun. 10, 2022, which is hereby incorporated by reference in its entirety.

### FIELD

Embodiments of the disclosure relates to the technical field of image processing, in particular to a method and apparatus for image processing, electronic device and a storage medium.

### BACKGROUND

When adding a bald head effect to the image of a target object with hair, usually, when collecting images, a physical headgear is worn to cover the original hair and directly capture the hairless bald image of the target object. Alternatively, images of the target object that originally had hair are collected, and manual image editing is used to remove the hair. Among these two methods, the former has a higher cost of headgear and the effect is not realistic enough, while the latter has a higher labor cost for image editing operations and cannot be processed in real time.

### SUMMARY

The disclosure provides a method and an apparatus for image processing, electronic device and a storage medium, to achieve a removal of a target object in an image in real time and reduce the removal cost of element object in the image.

Embodiments of the disclosure provides a method for image processing. The method comprises: obtaining an image to be processed, wherein the image to be processed is an image with a preset object, a portion of pixels of the preset object are located in a subject contour region in the image to be processed, and a further portion of pixels of the preset object are located outside the subject contour region; obtaining a target image by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

Embodiments of the disclosure further provides an apparatus for image processing. The apparatus comprises an image obtaining module, configured to obtain an image to be processed, wherein the image to be processed is an image with a preset object, a portion of pixels of the preset object are located in a subject contour region in the image to be processed, and a further portion of pixels of the preset object are located outside the subject contour region; an image processing module, configured to obtain a target image by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

An embodiment of the present disclosure further provides an electronic device, including: at least one processor; and a storage device, configured to store at least one program, when executed by the at least one processor, cause the at least one processor to implement the method for image processing according to any of the embodiments of the present disclosure.

An embodiment of the present disclosure further provides a storage medium including computer executable instructions that, when executed by a computer processor, are configured to perform the method for image processing according to any of the embodiments of the present disclosure.

### BRIEF DESCRIPTION OF DRAWINGS

Throughout the drawings, the same or similar reference numbers refer to the same or similar elements. It should be understood that the drawings are schematic, and elements and elements are not necessarily drawn to scale.

FIG. 1 is a schematic flowchart of a method for image processing according to an embodiment of the present disclosure;

FIG. 2 is a schematic diagram of an image to be processed according to an embodiment of the present disclosure;

FIG. 3 is a schematic flowchart of a method for image processing according to an embodiment of the present disclosure;

FIG. 4 is a schematic flowchart of a method for image processing according to an embodiment of the present disclosure;

FIG. 5 is a schematic diagram of image background patching according to an embodiment of the present disclosure;

FIG. 6 is a schematic diagram of facial skin patching according to an embodiment of the present disclosure;

FIG. 7 is a schematic structural diagram of an apparatus of image processing according to an embodiment of the present disclosure;

FIG. 8 is a schematic structural diagram of an electronic device according to an embodiment of the present disclosure.

### DETAILED DESCRIPTION

Embodiments of the present disclosure will be described below with reference to the accompanying drawings. While some embodiments of the present disclosure are shown in the drawings, it should be understood that the present disclosure may be implemented in a variety of forms and should not be construed as limited to the embodiments set forth herein. It should be understood that the drawings and embodiments of the present disclosure are for exemplary purposes only and are not intended to limit the scope of the present disclosure.

It should be understood that the steps described in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

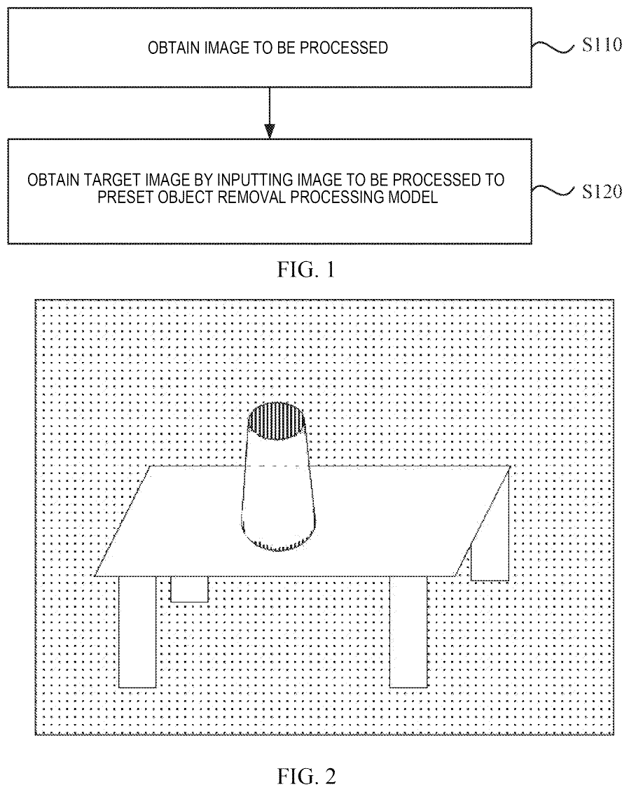

FIG. 1 is a schematic flowchart of a method for image processing according to an embodiment of the present disclosure.

As shown in FIG. 1, the method for image processing includes:

S110: Obtain image to be processed.

The to be processed image is an image including an image effect processing object, and may be an image obtained by downloading, photographing, or uploading.

In this embodiment, the image to be processed is an image with a preset object, the preset object is an image effect processing object in the image feature processing process, it is a target object to be removed and a portion of pixels of the preset object are located in the subject contour region in the image to be processed, and a further portion of pixels are located outside the subject contour region in the image to be processed. The pixels of the preset object located in different regions may be processed according to pixel information features of different portions respectively. The subject may be a foreground object of a portion of pixels containing the preset object in the image to be processed or a partial region of the foreground, and the subject contour is a line formed by edge pixels of a corresponding foreground or a partial region of the foreground.

It may be understood that, in the process of removing the preset object, the uniform pixel value may be substituted for the pixel value of the preset object, for example, the preset object becomes pure white or pure black, or the average pixel value of the image to be processed is used to replace the pixel value of the preset object. In order to make the effect of removing the preset object as if the preset object does not exist, different processing strategies need to be used for the pixels of the preset object at different portions in the image. After the pixels of the preset object in the subject contour range are removed, the pixel features of the subject in the image to be processed are represented, and after the pixels of the preset object outside the subject contour range are removed, the pixel features of the background other than the subject in the image to be processed are represented.

The preset object may be any object, and when the relationship between the preset object in the image to be processed and the foreground subject object in the image, satisfying a portion of pixels the preset object are located in the subject contour region in the image to be processed, and the other portion of pixels are located outside the subject contour region in the image to be processed, the image effect processing may be performed by the method for image processing of this embodiment.

For example, as shown in FIG. 2, an image to-be-processed, in which the subject is a dining table, the preset object is an object placed on the dining table, and the object is two portions separated by a dotted line, where a portion of pixels of the object are in a contour range of the dining table, and a further portion of pixels are outside a contour range of the dining table. The image effect processing effect of removing the object is that the pixels of the corresponding object in the subject contour range of the dining table subject is processed into pixels consistent with the dining table subject, and the pixels of the object corresponding to the outside of the subject contour range of the dining table subject is processed into pixels consistent with the background outside the dining table subject in the image to-be-processed.

S120: Obtain target image by inputting image to be processed to preset object removal processing model.

The target image is an object removal image corresponding to an image having a preset object, that is, an element of the preset object does not exist in the target image.

The preset object removal processing model may implement an effect of a removal of preset object in the image to be processed, and input the image to be processed including the preset object to the preset object removal processing model to obtain a corresponding output result, that is, the target image that does not include the preset object.

The preset object removal processing model may be a model obtained by training a set based on a pre-established set of image sample pairs without the preset object. Each preset object image sample pair includes an original image having a preset object, and a preset object removal image obtained by processing pixels of a preset object located outside the subject contour region in the original image and pixels of a preset object located in the subject contour region in the original image, respectively. Through the model training process, the preset object removal processing model can learn the mapping between the original image with the preset object and the corresponding preset object removal image to achieve the removal effect of the preset object.

The training process of the preset object removal processing model may include the following steps:

Step 1: Identify a subject contour region presenting the preset object in an original image with a preset object.

In this step, a corresponding subject contour region may be identified and extracted from the original image through an interactive image segmentation technology. Alternatively, other image recognition algorithms capable of identifying the subject in the image may also be used.

Step 2: obtain a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image. The consistency of the pixel information may be understood as the same pixel feature, or the effect that the pixel information appears visually is the same.

When the preset object pixels in the subject contour region and outside the subject contour region are processed, the preset object pixels in the subject contour region may be processed first, or the preset object pixels outside the subject contour region may be processed first, that is, the pixels of the preset object in one region are processed first, and then the pixels of the preset object of another region are processed on this basis. Alternatively, pixels of preset object in different regions may also be processed according to corresponding pixel processing strategies.

When the pixel of the preset object for one of the regions is processed, the average pixel value of the region may be used to replace the pixel value of the preset object, or interpolation may be used to perform interpolation calculation according to the pixel information of the region to obtain the updated pixel value of the preset object. In addition, the image processing neural network model for preset object pixel processing in different regions may be trained in a deep learning manner, to implement processing of preset object pixels in the original image, to obtain a preset object removal image.

Step 3: Obtain the preset object removal processing model by training the initial object removal model according to the original image and the preset object removal image to.

In the process of training the preset object removal model, the original image may be used as the model input, the preset object removal image is an output that is expected to output by the model, and when the preset training times and/or the preset model loss function reach the corresponding preset condition, the training process may be completed, to obtain the preset object removal processing model, which is used to remove the preset object.

According to the technical solution of the embodiments of the disclosure, when the image to be processed is obtained, the image to be processed is the image with the preset object, a portion of pixels of the preset object are located in the subject contour region in the image to be processed, and the other portion of pixels are located outside the subject contour region; the image to be processed can be input to a preset object removal processing model to obtain a target image after the preset object is removed, wherein the preset object removal processing model is a model obtained by training the set based on a pre-established set of image sample pairs without the preset object, each preset object image sample pair comprises an original image with a preset object, and the preset object pixel located outside the subject contour region and the preset object pixel located in the subject contour region are respectively subjected to processing to obtain a preset object removal image, so that the problem of low graph operation efficiency of removing the preset object in the image in the related technology is solved, the target object in the image can be removed in real time, and the time cost and the labor cost of removing the target object in the image are reduced.

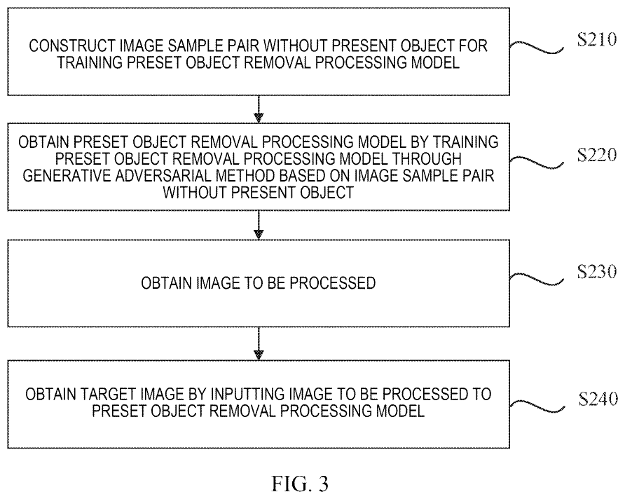

FIG. 3 is a schematic flowchart of still another method for image processing according to an embodiment of the present disclosure. The method may be performed by an apparatus of image processing, and the apparatus may be implemented in a form of software and/or hardware, optionally, implemented by an electronic device, and the electronic device may be a mobile terminal, a PC terminal, a server, or the like.

As shown in FIG. 3, the method for image processing includes the following steps.

S210: Construct image sample pair without present object for training preset object removal processing model.

When the preset object for hair removal is trained to remove the processing model, firstly, an image sample pairs without the preset object is constructed based on the image with preset object and an image without the preset object after the hair removal corresponding to the original image with the preset object.

Step 1: Identify a subject contour region presenting the preset object in an original image with a preset object.

Images with hair are mostly images containing human objects,, or an avatar of a person object. The subject corresponding to the hair, i.e., the preset object, includes a head of the person object, and when the subject contour region is identified, the head of the person object in the original image is identified. The head contour of the person in the original image can be extracted through a preset image segmentation technology to obtain a skull region binary image associated with the hair, and the subject contour represented by the skull region is represented in a mask mode. Alternatively, the original image with the preset object may be input to the skull region prediction model to obtain the skull region binary image presenting the preset object.

Step 2: Process pixels of the preset object located outside the subject contour region in the original image as pixels that have consistent pixel information of pixels of non-preset object outside the subject contour region in the original image.

The pixels of the preset object outside the skull region correspond to the background of the original image after removal. Causing the pixels of the preset object, when after processing, to have consistent pixel information of the pixels of the non-preset object outside the subject contour region in the original image is to cause the pixel of the preset object, when after processing, to be a part of the background of the original image, which can achieve the effect of removing the preset object without trace.

The skull region binary image may be superimposed with the original image in a deep learning manner, and the image superimposition result is input to the image background patching model, to obtain a primary object removal image for removing the preset object located outside the skull region. By superimposing the skull region binary image with the original image, the pixel information in the skull region of the original image can be temporarily masked. In the image processing process of the image background patching model, the influence of the pixel information in the skull region is avoided. Therefore, the pixels of the preset object outside the skull region can be processed according to the pixel information of the background outside the skull region, so that a better preset object removal effect is achieved.

Step 3: Process pixels of the preset object located in the subject contour region in the original image as pixels that have consistent pixel information of pixels of non-preset object within the subject contour region in the original image, on the basis of step 2.

After removing the hair in the skull region, the corresponding pixel positions of the hair are represented as the scalp. The primary object removal image obtained in step 2 can be input into the facial skin patching model to obtain a final object removal image that removes the preset objects located in the skull region.

The facial skin patching model is an image processing model obtained by training an bald head image without hair and an image obtained by superimposing an hairstyle mask in the skull region corresponding to the bald head image. The model can patch the facial skin of the region blocked by the hairstyle mask according to the pixel information in the skull region in the bald head image, so that a complete skull region image without hair can be obtained.

Step 4: Form the image sample pair without the preset object by using the original image and the preset object removal image.

S220: obtain preset object removal processing model by training preset object removal processing model through generative adversarial method based on image sample pair without present object.

In order to reduce the construction process of the image sample pair and the intermediate process of image processing, the time consumption of image processing is reduced, the obtained image sample pairs without the preset object can be input to a Pix2Pix model for learning, so that a preset object removal processing model is obtained, and finally an efficient preset object removal effect is achieved.

S230: Obtain image to be processed.

S240: Obtain target image by inputting image to be processed to preset object removal processing model.

According to the technical solution provided by the embodiments of the disclosure, image sample pairs without the preset object is constructed by obtaining image sample without the preset object through gradual processing based on the original image, to train the preset object removal processing model. After the image to be processed is obtained, the image to be processed is input to the preset object removal processing model to obtain the target image, which may solve the problem of unnatural image attribute effects in related technologies by adding special effects locally to the image, and achieve real-time removal of target objects in the image, reducing the cost of removing target objects in the image. In the process of constructing the model training sample pair, the skull region prediction model, the image background patching model, and the facial skin patching model are used to gradually obtain the preset object sample image corresponding to the original image, to obtain the model training sample pair with better image processing effect.

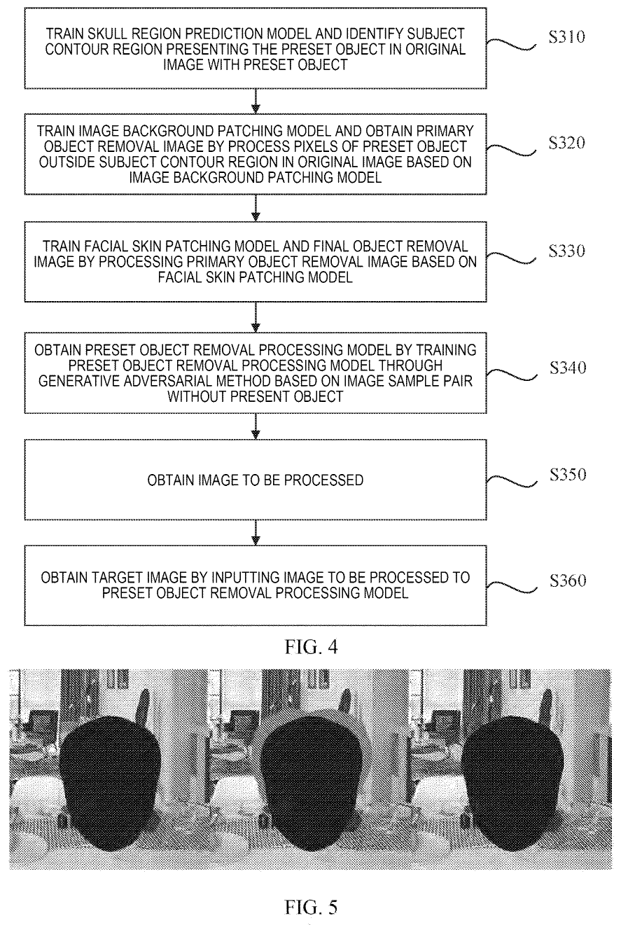

FIG. 4 is a schematic flowchart of still another method for image processing according to an embodiment of the present disclosure, and in a process of implementing the method flow, a training process of a preset object removal processing model is described when a target object to be removed is hair, in particular a process of constructing a training sample pair by training a skull region prediction model, an image background patching model, and a facial skin patching model. The method may be performed by an apparatus of image processing, and the apparatus may be implemented in a form of software and/or hardware, optionally, implemented by an electronic device, and the electronic device may be a mobile terminal, a PC terminal, a server, or the like.

S310: Train skull region prediction model and identify subject contour region presenting the preset object in original image with preset object.

The skull region may be understood as a real head region after hair (preset object) is removed, and the region may be represented by a black and white binary map. When the skull region prediction model is trained, firstly, a model training sample pair is constructed, and the model training sample pair includes an original image with a preset object and a binary image of a skull region corresponding to the original image. In the process of constructing the model training sample pair, a three-dimensional skull model can be established, the three-dimensional skull model can be arbitrarily adjusted to present different angles, and the skull contour can also be adjusted. Then, original sample images with the preset object of the plurality of known skull structures (such as the constructed three-dimensional skull model) are rendered. Then, for any original sample image with the preset object, a three-dimensional skull model corresponding to the presented angle is matched; and then the three-dimensional skull model is subjected to plane projection to obtain a skull region binary image matched with the original sample image. In addition, the contour of the skull region binary image may also be adjusted according to the facial contour of the person object in the original sample image. Finally, the original sample image may be used as a model input image, and the corresponding skull region binary image is used as a model expected output image to perform neural network model training to obtain a skull region prediction model.

The trained skull region prediction model may be used to predict the subject contour region (i.e., the skull region) of the original image with the preset object.

S320: Train image background patching model and obtain primary object removal image by process pixels of preset object outside subject contour region in original image based on image background patching model.

After the skull region corresponding to the original sample image is obtained, in order to obtain the hairless state by hair removal, the hair can be divided into the hair inside the skull region and the hair outside the skull region, the hair outside the skull needs to be processed as the background, and the hair inside the skull region needs to be processed into facial skin. The image background patching model is a model for processing hair outside the skull region.

In the process of training the image background patching model, firstly, the skull region binary image in the preset skull region binary image set and the background image in the preset background image set are randomly combined to obtain a plurality of combinations, and the skull region binary image in each combination is superimposed on the background image to obtain a first superimposed sample image, as shown in the left image in FIG. 5. As shown in the left image in FIG. 5, the skull region of one skull region binary image is represented by black, and the skull region binary image is randomly superimposed with a background image to obtain a first superimposed sample image, so that the processing is equivalent to blocking the pixel information inside the skull region, and the pixel information inside the skull region is not extracted in the process of model learning image features. Then, preset object pixel marker is performed on the outside of the corresponding skull region in the first superimposed sample image to obtain a first superimposed sample labeled image, such as the intermediate image in FIG. 5, where the gray region represents the preset object pixel label. It may be understood that the region of the preset object pixel marker may be set with reference to different hairstyles. Finally, a neural network model training is performed based on the first superimposed sample image and the first superimposed sample labeled image to obtain an image background patching model. Inputting the first superimposed sample labelled image into the initial image background patching model to obtain a first model generation image; inputting the first model generation image and any background image except the background image in the first superimposed sample image in the preset background image set into the first discriminator; and updating the initial image background patching model based on the output result of the first discriminator and the comparison result between the first model generation image and the first superimposed sample image to obtain the image background patching model. The image background patching model is used to process the first superimposed sample marker image to obtain the background patching effect shown in the right image in FIG. 5.

It should be noted that, in the training process of the background patching model, the addition of the first discriminator may be that the result of the image background patching is closer to the real background image, and the effect is more natural, so that the discriminator cannot distinguish whether the background image is the original background image or the repaired background image. Moreover, in the model training process, there may be a certain acceptable error between the first model generation image and the first superimposed sample image, and it is not mandatory that the first model generation image and the first superimposed sample image are exactly the same, thereby avoiding over-fitting of the model.

S330: Train facial skin patching model and final object removal image by processing primary object removal image based on facial skin patching model.

On the basis of the above image processing step, the pixel of the preset object in the skull region needs to be processed, that is, the pixel of the preset object in the skull region is processed into a pixel consistent with the facial skin.

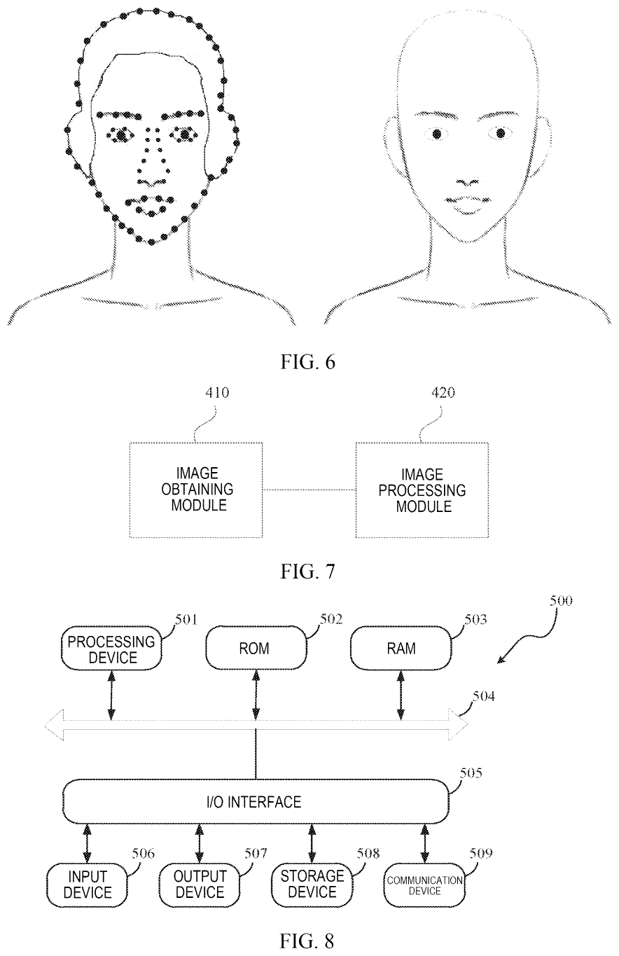

In a process of training a facial skin patching model, first, for any sample image that does not include a preset object (for example, a non-hair task object image), a preset object mask image is superimposed in a skull region of a sample image that does not include a preset object, to obtain a second superimposed sample image, as shown in the left image in FIG. 6, where the white region is a preset object mask image. It may be understood that the preset object mask image may be set with reference to a plurality of hairstyles. Then, a second superimposed sample image labelled with the preset number of skull region anchors is obtained by collecting a preset number of skull region anchors in a skull region of the second superimposed sample image according to a preset calibration point collection strategy. The skull region anchor point may serve as assistance reference information of the trained neural network model, so that the neural network model can distinguish the feature in the region range corresponding to the skull region and outside the skull region. Finally, the facial skin patching model is obtained by performing a neural network model training on the second superimposed sample image labelled with the preset number of skull region anchors and the collected sample image that does not include a preset object (such as the right image in FIG. 6). The strategy for collecting the anchor point of the skull region may be: performing anchor sampling according to a facial feature contour inside a skull region of the second superimposed sample image; performing anchor sampling on a contour edge of the skull region of the second superimposed sample image at the contour edge based on a preset sampling interval, and the anchor point acquisition result may refer to the black point in the left image in FIG. 6.

In the training process of the facial skin patching model, a second model generation image may be obtained by inputting all second superimposed sample images labelled with the preset number of skull region anchors into the initial facial skin patching model; the second model generation image and a sample image that does not include a preset object other than a collected sample image that does not include the preset object corresponding to the second superimposed sample image may be input to the second discriminator; the facial skin patching model may be obtained by updating the initial facial skin patching model based on an output result of the second discriminator and a comparison result of the second model generation image and the collected sample image that does not include a preset object corresponding to the second superimposed sample image.

It should be noted that, in the training process of the facial skin patching model, the addition of the second discriminator may be to make the result of repairing the facial skin of the image closer to the actual image of the character object without the preset object, and the effect is more natural, so that the discriminator cannot distinguish whether the image of the character object which is the original preset object or the image of the preset object which is repaired by the facial skin.

S340: obtain preset object removal processing model by training preset object removal processing model through generative adversarial method based on image sample pair without present object.

In order to reduce the construction process of the image sample pair and the intermediate process of image processing and the time consumption of image processing is reduced, the obtained set of image sample pairs without the preset object can be input to a Pix2Pix model for learning, so that a preset object removal processing model is obtained, and finally an efficient preset object removal effect is achieved.

S350: Obtain image to be processed.

S360: Obtain target image by inputting image to be processed to preset object removal processing model.

According to the technical solution provided by the embodiments of the disclosure, the skull region prediction model, the background patching model and the facial skin patching model are respectively trained, image sample pairs without the preset object is constructed by obtaining image sample without the preset object through gradual processing based on the original image, to train the preset object removal processing model. After the image to be processed is obtained, the image to be processed is input to the preset object removal processing model to obtain the target image, which may solve the problem of unnatural image attribute effects in related technologies by adding special effects locally to the image, and achieve real-time removal of target objects in the image, reducing the cost of removing target objects in the image. In the process of constructing the model training sample pair, the skull region prediction model, the image background patching model, and the facial skin patching model are used to gradually obtain the preset object sample image corresponding to the original image, to obtain the model training sample pair with better image processing effect.

FIG. 7 is a schematic structural diagram of an apparatus of image processing according to an embodiment of the present disclosure.

As shown in FIG. 7, the apparatus of image processing includes an image obtaining module 410 and an image processing module 420.

An image obtaining module, configured to obtain an image to be processed, wherein the image to be processed is an image with a preset object, a portion of pixels of the preset object are located in a subject contour region in the image to be processed, and a further portion of pixels of the preset object are located outside the subject contour region; an image processing module, configured to obtain a target image by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

According to the technical solution provided by the embodiments of the disclosure, the image to be processed is obtained, wherein the image to be processed is an image with a preset object, a portion of pixels of the preset object are located in a subject contour region in the image to be processed, and a further portion of pixels of the preset object are located outside the subject contour region; the target image is obtained by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively, so that the problem that the image attribute effect is not natural in a manner of locally adding effects in the image in the related technology is solved, the target object in the image can be removed in real time, and the removal cost of the target object in the image is reduced.

In an optional implementation, the apparatus of image processing further includes a model training sample construction module configured to: identify a subject contour region presenting the preset object in an original image with a preset object; obtain a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image; form the image sample pair without the preset object by using the original image and the preset object removal image.

In an optional implementation, when the preset object is hair, and the subject contour region is a skull region, the model training sample construction module is configured to: obtain a skull region binary image presenting the preset object by inputting an original image with a preset object into a skull region prediction model; obtain a primary object removal image after removing the preset object located outside the skull region in the original image by obtaining an image superimposition result by superimposing the skull region binary image and the original image and inputting the image superimposition result to an image background patching model; obtain a final object removal image after removing the preset object located in the skull region in the original image by inputting the primary object removal image into a facial skin patching model; form the image sample pair without the preset object from the original image and the final object removal image.

In an optional implementation, the apparatus of image processing further includes a first auxiliary model training module, configured to train the skull region prediction model, and the training process includes the following steps: obtain a sample image with the preset object for which a corresponding three-dimensional skull model is matched; obtain a skull region binary image matching the sample image by performing planar projection on the three-dimensional skull model; obtain the skull region prediction model by performing neural network model training with the sample image as a model input image and with a skull region binary image matching the sample image as a model expected output image.

In an optional implementation, the apparatus of image processing further includes a second auxiliary model training module configured to train the image background patching model, and the training process includes the following steps: obtain a first superimposed sample image by obtaining a plurality of combinations from a randomly combination of a skull region binary image in a preset skull region binary image set and a background image in a preset background image set and superimposing a skull region binary image in each combination on a background image in each combination; obtain a first superimposed sample labeled image by labeling a preset object pixel label on outside of a corresponding skull region in the first superimposed sample image; obtain the image background patching model by performing a neural network model training based on the first superimposed sample image and the first superimposed sample labeled image.

In an optional implementation, the second auxiliary model training module is configured to: obtain a first model generation image by inputting the first superimposed sample labelled image to an initial image background patching model; input the first model generation image and a background image in the preset background image set other than a background image in the first superimposed sample image into the first discriminator; obtain the image background patching model by updating the initial image background patching model based on an output result of the first discriminator and a comparison result between the first model generation image and the first superimposed sample image.

In an optional implementation, the apparatus of image processing further includes a third auxiliary model training module configured to train the facial skin patching model, and the training process includes: obtain a second superimposed sample image by superimpose the preset object mask image within the skull region of a collected sample image that does not contain the preset object; obtain a second superimposed sample image labelled with the preset number of skull region anchors by collecting a preset number of skull region anchors in a skull region of the second superimposed sample image according to a preset calibration point collection strategy; obtain the facial skin patching model by performing a neural network model training on the second superimposed sample image labelled with the preset number of skull region anchors and the collected sample image that does not include a preset object.

In an optional implementation, the third auxiliary model training module is configured to: obtain a second model generation image by inputting all second superimposed sample images labelled with the preset number of skull region anchors into the initial facial skin patching model; input the second model generation image and a sample image that does not include a preset object other than a collected sample image that does not include the preset object corresponding to the second superimposed sample image into the second discriminator; obtain the facial skin patching model by updating the initial facial skin patching model based on an output result of the second discriminator and a comparison result of the second model generation image and the collected sample image that does not include a preset object corresponding to the second superimposed sample image.

In an optional implementation, the third auxiliary model training module may be further configured to: perform anchor sampling according to a facial feature contour inside a skull region of the second superimposed sample image; perform anchor sampling on a contour edge of the skull region of the second superimposed sample image at the contour edge based on a preset sampling interval.

The apparatus of image processing provided by the embodiments of the present disclosure may perform the method for image processing provided by any embodiment of the present disclosure and has functional modules corresponding to the execution method.

It should be noted that, a plurality of units and modules included in the foregoing apparatus are only divided according to function logic, but are not limited to the foregoing division, as long as a corresponding function can be implemented; in addition, names of the plurality of function units are merely for convenience of distinguishing, and are not used to limit the protection scope of the embodiments of the present disclosure.

FIG. 8 is a schematic structural diagram of an electronic device according to an embodiment of the present disclosure. FIG. 8 is a schematic structural diagram of an electronic device 500 (such as the terminal device or server in FIG. 8) suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital television (TV), a desktop computer, or the like. The electronic device 500 shown in FIG. 8 is merely an example, and should not impose any limitation on the functions and scope of use of the embodiments of the present disclosure.

As shown in FIG. 8, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. Although FIG. 8 illustrates an electronic device 500 having a variety of devices, it is to be understood that all illustrated devices are not required to be implemented or provided. More or fewer devices may alternatively be implemented or provided.

According to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the method for image processing provided in the foregoing embodiments belong to the same inventive concept, and technical details not described in detail in this embodiment may refer to the foregoing embodiments.

An embodiment of the present disclosure provides a computer storage medium having a computer program stored thereon, the program, when executed by a processor, implements the method for image processing provided in the foregoing embodiments.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. Examples of the computer-readable storage medium may include, but are not limited to, an electrical connection having one or more wires, a portable computer diskette, a hard disk, a RAM, a ROM, an erasable programmable read-only memory (EPROM) or a flash memory, an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), etc., or any suitable combination thereof.

In some implementations, the client, server may communicate using any currently known or future developed network protocol, such as Hypertext Transfer Protocol (HTTP), and may be interconnected with any form or medium of digital data communication (e.g., a communication network). Examples of communication networks include Local Region Networks (LANs), Wide Region Networks (WANs), Internet networks (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is caused to: obtain an image to be processed, wherein the image to be processed is an image with a preset object, a portion of pixels of the preset object are located in a subject contour region in the image to be processed, and a further portion of pixels of the preset object are located outside the subject contour region; input the image to be processed to a preset object removal processing model to obtain a target image, wherein the target image is an object removal image corresponding to an image with a preset object; the preset object removal processing model is a model obtained by training a set based on a pre-established preset object image sample pair set, wherein each preset object image sample pair in the preset object image sample pair set comprises an original image with a preset object, and separately process a preset object pixel located outside the subject contour region and a preset object pixel located in the subject contour region to obtain a preset object removal image.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a LAN or WAN, or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the unit does not constitute a limitation on the unit itself, for example, the first obtaining unit may be further described as “unit for obtaining at least two Internet Protocol addresses”.

The functions described above may be performed, at least in part, by one or more hardware logic components. For example, without limitation, the exemplary types of hardware logic components that may be used include: a field programmable gate array (FPGA), an application specific integrated circuit (ASIC), an application specific standard (ASSP), a system on chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer diskettes, hard disks, RAMs, ROMs, EPROMs or flash memories, optical fibers, CD-ROMs, optical storage devices, magnetic storage devices, or any suitable combination of the foregoing.

According to one or more embodiments of the present disclosure, there is provided a method for image processing (example 1), comprising: obtaining an image to be processed, wherein the image to be processed is an image with a preset object, a portion of pixels of the preset object are located in a subject contour region in the image to be processed, and a further portion of pixels of the preset object are located outside the subject contour region; obtaining a target image by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

According to one or more embodiments of the present disclosure, there is provided a method for image processing (example 2), further comprising: in some optional implementations, construction process of an image sample pair without the preset object in the set of image sample pairs without the preset object comprises: identifying a subject contour region presenting the preset object in an original image with a preset object; obtaining a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image; forming the image sample pair without the preset object by using the original image and the preset object removal image.

According to one or more embodiments of the present disclosure, there is provided a method for image processing (example 3), including: in some optional implementations, the preset object is hair and the subject contour region is a skull region, and a construction process of a image sample pair without the preset object in the set of image sample pairs without the preset object comprises: obtaining a skull region binary image presenting the preset object by inputting an original image with a preset object into a skull region prediction model; obtaining a primary object removal image after removing the preset object located outside the skull region in the original image by obtaining an image superimposition result by superimposing the skull region binary image and the original image and inputting the image superimposition result to an image background patching model; obtaining a final object removal image after removing the preset object located in the skull region in the original image by inputting the primary object removal image into a facial skin patching model; forming the image sample pair without the preset object from the original image and the final object removal image.

According to one or more embodiments of the present disclosure, there is provided a method for image processing (example 4), further comprising: in some optional implementations, training process of the skull region prediction model comprises: obtaining a sample image with the preset object for which a corresponding three-dimensional skull model is matched; obtaining a skull region binary image matching the sample image by performing planar projection on the three-dimensional skull model; obtaining the skull region prediction model by performing neural network model training with the sample image as a model input image and with a skull region binary image matching the sample image as a model expected output image.

According to one or more embodiments of the present disclosure, there is provided a method for image processing (example 5), further comprising: in some optional implementations, the training process of the image background patching model comprises: obtaining a first superimposed sample image by obtaining a plurality of combinations from a randomly combination of a skull region binary image in a preset skull region binary image set and a background image in a preset background image set and superimposing a skull region binary image in each combination on a background image in each combination; obtaining a first superimposed sample labeled image by labeling a preset object pixel label on outside of a corresponding skull region in the first superimposed sample image; obtaining the image background patching model by performing a neural network model training based on the first superimposed sample image and the first superimposed sample labeled image.

According to one or more embodiments of the present disclosure, there is provided a method for image processing (example 6), further comprising: in some optional implementations, the obtaining the image background patching model by performing a neural network model training based on the first superimposed sample image and the first superimposed sample labeled image comprises: obtaining a first model generation image by inputting the first superimposed sample labelled image to an initial image background patching model; inputting the first model generation image and a background image in the preset background image set other than a background image in the first superimposed sample image into the first discriminator; obtaining the image background patching model by updating the initial image background patching model based on an output result of the first discriminator and a comparison result between the first model generation image and the first superimposed sample image.

According to one or more embodiments of the present disclosure, there is provided a method for image processing (example 7), further comprising: a training process of the facial skin patching model comprises: obtaining a second superimposed sample image by superimpose the preset object mask image within the skull region of a collected sample image that does not contain the preset object; obtaining a second superimposed sample image labelled with the preset number of skull region anchors by collecting a preset number of skull region anchors in a skull region of the second superimposed sample image according to a preset calibration point collection strategy; obtaining the facial skin patching model by performing a neural network model training on the second superimposed sample image labelled with the preset number of skull region anchors and the collected sample image that does not include a preset object.

According to one or more embodiments of the present disclosure, there is provided a method for image processing (example 8), further comprising: in an optional implementation, the obtaining the facial skin patching model by performing a neural network model training on the second superimposed sample image labelled with the preset number of skull region anchors and the collected sample image that does not include a preset object comprises: obtaining a second model generation image by inputting all second superimposed sample images labelled with the preset number of skull region anchors into the initial facial skin patching model; inputting the second model generation image and a sample image that does not include a preset object other than a collected sample image that does not include the preset object corresponding to the second superimposed sample image into the second discriminator; obtaining the facial skin patching model by updating the initial facial skin patching model based on an output result of the second discriminator and a comparison result of the second model generation image and the collected sample image that does not include a preset object corresponding to the second superimposed sample image.

According to one or more embodiments of the present disclosure, there is provided a method for image processing (example 9), further comprising: in an optional implementation, the collecting a preset number of skull region anchors in a skull region of the second superimposed sample image according to a preset calibration point collection strategy comprises: performing anchor sampling according to a facial feature contour inside a skull region of the second superimposed sample image; performing anchor sampling on a contour edge of the skull region of the second superimposed sample image at the contour edge based on a preset sampling interval.

According to one or more embodiments of the present disclosure, there is provided an apparatus of image processing (example 10), comprising: an image obtaining module, configured to obtain an image to be processed, wherein the image to be processed is an image with a preset object, a portion of pixels of the preset object are located in a subject contour region in the image to be processed, and a further portion of pixels of the preset object are located outside the subject contour region; an image processing module, configured to obtain a target image by inputting the image to be processed to a preset object removal processing model, wherein the target image is an object removal image corresponding to the image with the preset object; the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

According to one or more embodiments of the present disclosure, there is provided an apparatus of image processing (example 11), further comprising: in an optional implementation, the apparatus of image processing further includes a model training sample construction module configured to: identify a subject contour region presenting the preset object in an original image with a preset object; obtain a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image; form the image sample pair without the preset object by using the original image and the preset object removal image.

According to one or more embodiments of the present disclosure, there is provided an apparatus of image processing (example 12), further comprising: in an optional implementation, when the preset object is hair, and the subject contour region is a skull region, the model training sample construction module is configured to: obtain a skull region binary image presenting the preset object by inputting an original image with a preset object into a skull region prediction model; obtain a primary object removal image after removing the preset object located outside the skull region in the original image by obtaining an image superimposition result by superimposing the skull region binary image and the original image and inputting the image superimposition result to an image background patching model; obtain a final object removal image after removing the preset object located in the skull region in the original image by inputting the primary object removal image into a facial skin patching model; form the image sample pair without the preset object from the original image and the final object removal image.

According to one or more embodiments of the present disclosure, there is provided an apparatus of image processing (example 13), which further includes: in an optional implementation, the apparatus of image processing further includes a first auxiliary model training module, configured to train the skull region prediction model, and the training process includes the following steps: obtain a sample image with the preset object for which a corresponding three-dimensional skull model is matched; obtain a skull region binary image matching the sample image by performing planar projection on the three-dimensional skull model; obtain the skull region prediction model by performing neural network model training with the sample image as a model input image and with a skull region binary image matching the sample image as a model expected output image.

According to one or more embodiments of the present disclosure, there is provided an apparatus of image processing (example 14), which further includes: in an optional implementation, the apparatus of image processing further includes a second auxiliary model training module configured to train the image background patching model, and the training process includes the following steps: obtain a first superimposed sample image by obtaining a plurality of combinations from a randomly combination of a skull region binary image in a preset skull region binary image set and a background image in a preset background image set and superimposing a skull region binary image in each combination on a background image in each combination; obtain a first superimposed sample labeled image by labeling a preset object pixel label on outside of a corresponding skull region in the first superimposed sample image; obtain the image background patching model by performing a neural network model training based on the first superimposed sample image and the first superimposed sample labeled image.

According to one or more embodiments of the present disclosure, there is provided an apparatus of image processing (example 15), further comprising: in an optional implementation, the second auxiliary model training module is configured to: obtain a first model generation image by inputting the first superimposed sample labelled image to an initial image background patching model; input the first model generation image and a background image in the preset background image set other than a background image in the first superimposed sample image into the first discriminator; obtain the image background patching model by updating the initial image background patching model based on an output result of the first discriminator and a comparison result between the first model generation image and the first superimposed sample image.

According to one or more embodiments of the present disclosure, there is provided an apparatus of image processing (example 16), further comprising: in an optional implementation, the apparatus of image processing further includes a third auxiliary model training module configured to train the facial skin patching model, and the training process includes: obtain a second superimposed sample image by superimpose the preset object mask image within the skull region of a collected sample image that does not contain the preset object; obtain a second superimposed sample image labelled with the preset number of skull region anchors by collecting a preset number of skull region anchors in a skull region of the second superimposed sample image according to a preset calibration point collection strategy; obtain the facial skin patching model by performing a neural network model training on the second superimposed sample image labelled with the preset number of skull region anchors and the collected sample image that does not include a preset object.

According to one or more embodiments of the present disclosure, there is provided an apparatus of image processing (example 17), further comprising: in an optional implementation, the third auxiliary model training module is configured to: obtain a second model generation image by inputting all second superimposed sample images labelled with the preset number of skull region anchors into the initial facial skin patching model; input the second model generation image and a sample image that does not include a preset object other than a collected sample image that does not include the preset object corresponding to the second superimposed sample image into the second discriminator; obtain the facial skin patching model by updating the initial facial skin patching model based on an output result of the second discriminator and a comparison result of the second model generation image and the collected sample image that does not include a preset object corresponding to the second superimposed sample image.

According to one or more embodiments of the present disclosure, there is provided an apparatus of image processing (example 18), further comprising: in an optional implementation, the third auxiliary model training module may be further configured to: perform anchor sampling according to a facial feature contour inside a skull region of the second superimposed sample image; perform anchor sampling on a contour edge of the skull region of the second superimposed sample image at the contour edge based on a preset sampling interval.

The above description is only an alternative embodiment of the present disclosure and an explanation of the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while multiple operations are depicted in a particular order, this should not be understood to require that these operations be performed in the particular order shown or in sequential order. In certain circumstances, multitasking and parallel processing may be advantageous. Likewise, while multiple implementation details are included in the discussion above, these should not be construed as limiting the scope of the present disclosure. Some features described in the context of separate embodiments may also be implemented in combination in a single embodiment. Conversely, the various features described in the context of a single embodiment may also be implemented in multiple embodiments either individually or in any suitable sub-combination.

1-12. (canceled)

13. A method for image processing comprising:
obtaining an image to be processed, wherein the image to be processed is an image with a preset object, a portion of pixels of the preset object are located in a subject contour region in the image to be processed, and a further portion of pixels of the preset object are located outside the subject contour region;
obtaining a target image by inputting the image to be processed to a preset object removal processing model, wherein the target image is an object removal image corresponding to the image with the preset object; and
the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

14. The method of claim 13, wherein a construction process of an image sample pair without the preset object in the set of image sample pairs without the preset object comprises:
identifying a subject contour region presenting the preset object in an original image with a preset object;
obtaining a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image; and
forming the image sample pair without the preset object by using the original image and the preset object removal image.

15. The method of claim 13, wherein the preset object is hair and the subject contour region is a skull region, and wherein a construction process of a image sample pair without the preset object in the set of image sample pairs without the preset object comprises:
obtaining a skull region binary image presenting the preset object by inputting an original image with a preset object into a skull region prediction model;
obtaining a primary object removal image after removing the preset object located outside the skull region in the original image by obtaining an image superimposition result by superimposing the skull region binary image and the original image and inputting the image superimposition result to an image background patching model;
obtaining a final object removal image after removing the preset object located in the skull region in the original image by inputting the primary object removal image into a facial skin patching model; and
forming the image sample pair without the preset object from the original image and the final object removal image.

16. The method of claim 15, wherein a training process of the skull region prediction model comprises:
obtaining a sample image with the preset object for which a corresponding three-dimensional skull model is matched;
obtaining a skull region binary image matching the sample image by performing planar projection on the three-dimensional skull model; and
obtaining the skull region prediction model by performing neural network model training with the sample image as a model input image and with a skull region binary image matching the sample image as a model expected output image.

17. The method of claim 15, wherein the training process of the image background patching model comprises:
obtaining a first superimposed sample image by obtaining a plurality of combinations from a randomly combination of a skull region binary image in a preset skull region binary image set and a background image in a preset background image set and superimposing a skull region binary image in each combination on a background image in each combination;
obtaining a first superimposed sample labeled image by labeling a preset object pixel label on outside of a corresponding skull region in the first superimposed sample image; and
obtaining the image background patching model by performing a neural network model training based on the first superimposed sample image and the first superimposed sample labeled image.

18. The method of claim 17, wherein the obtaining the image background patching model by performing a neural network model training based on the first superimposed sample image and the first superimposed sample labeled image comprises:
obtaining a first model generation image by inputting the first superimposed sample labelled image to an initial image background patching model;
inputting the first model generation image and a background image in the preset background image set other than a background image in the first superimposed sample image into a first discriminator; and
obtaining the image background patching model by updating the initial image background patching model based on an output result of the first discriminator and a comparison result between the first model generation image and the first superimposed sample image.

19. The method of claim 15, wherein a training process of the facial skin patching model comprises:
obtaining a second superimposed sample image by superimposing a preset object mask image within the skull region of a collected sample image that does not contain the preset object;
obtaining a second superimposed sample image labelled with a preset number of skull region anchors by collecting the preset number of skull region anchors in a skull region of the second superimposed sample image according to a preset calibration point collection strategy; and
obtaining the facial skin patching model by performing a neural network model training on the second superimposed sample image labelled with the preset number of skull region anchors and the collected sample image that does not include a preset object.

20. The method of claim 19, wherein the obtaining the facial skin patching model by performing the neural network model training on the second superimposed sample image labelled with the preset number of skull region anchors and the collected sample image that does not include the preset object comprises:
obtaining a second model generation image by inputting all second superimposed sample images labelled with the preset number of skull region anchors into an initial facial skin patching model;
inputting the second model generation image and a sample image that does not include a preset object other than a collected sample image that does not include the preset object corresponding to the second superimposed sample image into a second discriminator; and
obtaining the facial skin patching model by updating the initial facial skin patching model based on an output result of the second discriminator and a comparison result of the second model generation image and the collected sample image that does not include a preset object corresponding to the second superimposed sample image.

21. The method of claim 19, wherein the collecting the preset number of skull region anchors in the skull region of the second superimposed sample image according to the preset calibration point collection strategy comprises:
performing anchor sampling according to a facial feature contour inside the skull region of the second superimposed sample image; and
performing anchor sampling on a contour edge of the skull region of the second superimposed sample image at the contour edge based on a preset sampling interval.

22. An electronic device includes:
at least one processor;
a storage device configured to store at least one program, wherein when the at least one program is executed by the at least one processor, the at least one processor implements a method comprising:
obtaining an image to be processed, wherein the image to be processed is an image with a preset object, a portion of pixels of the preset object are located in a subject contour region in the image to be processed, and a further portion of pixels of the preset object are located outside the subject contour region;
obtaining a target image by inputting the image to be processed to a preset object removal processing model, wherein the target image is an object removal image corresponding to the image with the preset object; and
the preset object removal processing model is a model obtained by training based on a pre-established set of image sample pairs without the preset object, wherein each image sample pair without the preset object in the set of image sample pairs without the preset object comprises an original image with a preset object, and a preset object removal image obtained by processing pixels of a preset object located outside the subject contour region in the original image and pixels of a preset object located in the subject contour region in the original image, respectively.

23. The device of claim 22, wherein a construction process of an image sample pair without the preset object in the set of image sample pairs without the preset object comprises:
identifying a subject contour region presenting the preset object in an original image with a preset object;
obtaining a preset object removal image by processing pixels of the preset object located in the subject contour region in the original image as pixels that have consistent pixel information of pixels of non-preset object within the subject contour region in the original image and processing pixels of the preset object located outside the subject contour region in the original image as pixels that have consistent pixel information of pixels of non-preset object outside the subject contour region in the original image; and
forming the image sample pair without the preset object by using the original image and the preset object removal image.

24. The device of claim 22, wherein the preset object is hair and the subject contour region is a skull region, and wherein a construction process of a image sample pair without the preset object in the set of image sample pairs without the preset object comprises:
obtaining a skull region binary image presenting the preset object by inputting an original image with a preset object into a skull region prediction model;
obtaining a primary object removal image after removing the preset object located outside the skull region in the original image by obtaining an image superimposition result by superimposing the skull region binary image and the original image and inputting the image superimposition result to an image background patching model;
obtaining a final object removal image after removing the preset object located in the skull region in the original image by inputting the primary object removal image into a facial skin patching model; and
forming the image sample pair without the preset object from the original image and the final object removal image.

25. The device of claim 24, wherein a training process of the skull region prediction model comprises:
obtaining a sample image with the preset object for which a corresponding three-dimensional skull model is matched;
obtaining a skull region binary image matching the sample image by performing planar projection on the three-dimensional skull model; and
obtaining the skull region prediction model by performing neural network model training with the sample image as a model input image and with a skull region binary image matching the sample image as a model expected output image.

26. The device of claim 24, wherein the training process of the image background patching model comprises:
obtaining a first superimposed sample image by obtaining a plurality of combinations from a randomly combination of a skull region binary image in a preset skull region binary image set and a background image in a preset background image set and superimposing a skull region binary image in each combination on a background image in each combination;
obtaining a first superimposed sample labeled image by labeling a preset object pixel label on outside of a corresponding skull region in the first superimposed sample image; and
obtaining the image background patching model by performing a neural network model training based on the first superimposed sample image and the first superimposed sample labeled image.

27. The device of claim 26, wherein the obtaining the image background patching model by performing a neural network model training based on the first superimposed sample image and the first superimposed sample labeled image comprises:
obtaining a first model generation image by inputting the first superimposed sample labelled image to an initial image background patching model;
inputting the first model generation image and a background image in the preset background image set other than a background image in the first superimposed sample image into a first discriminator; and
obtaining the image background patching model by updating the initial image background patching model based on an output result of the first discriminator and a comparison result between the first model generation image and the first superimposed sample image.

28. The device of claim 24, wherein a training process of the facial skin patching model comprises:
obtaining a second superimposed sample image by superimposing a preset object mask image within the skull region of a collected sample image that does not contain the preset object;
obtaining a second superimposed sample image labelled with a preset number of skull region anchors by collecting the preset number of skull region anchors in a skull region of the second superimposed sample image according to a preset calibration point collection strategy; and
obtaining the facial skin patching model by performing a neural network model training on the second superimposed sample image labelled with the preset number of skull region anchors and the collected sample image that does not include a preset object.

29. The device of claim 28, wherein the obtaining the facial skin patching model by performing the neural network model training on the second superimposed sample image labelled with the preset number of skull region anchors and the collected sample image that does not include the preset object comprises:
obtaining a second model generation image by inputting all second superimposed sample images labelled with the preset number of skull region anchors into an initial facial skin patching model;
inputting the second model generation image and a sample image that does not include a preset object other than a collected sample image that does not include the preset object corresponding to the second superimposed sample image into a second discriminator; and
obtaining the facial skin patching model by updating the initial facial skin patching model based on an output result of the second discriminator and a comparison result of the second model generation image and the collected sample image that does not include a preset object corresponding to the second superimposed sample image.

30. The device of claim 28, wherein the collecting the preset number of skull region anchors in the skull region of the second superimposed sample image according to the preset calibration point collection strategy comprises:
performing anchor sampling according to a facial feature contour inside the skull region of the second superimposed sample image; and
performing anchor sampling on a contour edge of the skull region of the second superimposed sample image at the contour edge based on a preset sampling interval.

31. A non-transitory computer-readable storage medium having stored thereon a computer program, wherein the computer program, when executed by a processor, implements a method comprising:
inputting an original image into a predetermined model;
outputting a prediction result for at least one prediction task of the original image by the predetermined model; and
wherein the at least one prediction task comprises a key point prediction task, and wherein a loss item of the predetermined model in a training process comprises a first loss constructed based on an error distribution between a first prediction result of the key point prediction task and a key point position label.
